(19) United States
(12) Patent Application Publication
(10) Pub. No.: US 2026/0104878 A1
(43) Pub. Date: Apr. 16, 2026

(54) DYNAMIC EDGE CONTROLLER CODE OPTIMIZATION

(71) Applicant: INTERNATIONAL BUSINESS MACHINES CORPORATION, Armonk, NY (US)

(72) Inventors: Maja CURIC, Munich (DE); Sagar TAYAL, Ambala City (IN); Alecio Pedro Delazari BINOTTO, Munich (DE)

(21) Appl. No.: 18/912,693

(22) Filed: Oct. 11, 2024

(51) Int. Cl. G06F 8/65

(52) U.S. Cl. CPC G06F 8/65

(57) ABSTRACT

Dynamic code optimization is provided for network edge controllers of a network. The process includes predicting, via data analytics, edge condition development for a network edge controller, where the network includes a plurality of network edge controllers with respective edge conditions. Further, the process includes determining, based on the predicting, that code governing one or more edge operations at the network edge controller can be optimized, and obtaining, based on the determining, optimized code to replace the code governing the one or more edge operations at the network edge controller. The optimized code is obtained to optimize the one or more edge operations for the predicted edge condition development. Further, the process includes transmitting the optimized code to the network edge controller for deployment to optimize the one or more edge operations at the network edge controller based on the predicted edge condition development.

### BACKGROUND

One or more aspects relate, in general, to facilitating processing within a computing environment, and more particularly, to improving edge computing in a network, such as a cellular network, by dynamically optimizing network edge-controller-code for one or more predicted edge conditions.

In a cloud environment, edge computing (i.e., computing at or near a boundary) enables processing and/or storage of data to be provided closer to the device(s) where operations are being performed. Accordingly, edge computing can eliminate the need for data to be processed or stored being transmitted to a central location (e.g., a central cloud server), which may be physically located a significant distance from the device(s). Although this configuration may not provide a substantial change to the services being provided from an individual device perspective, the large increase of Internet of Things (IoT), and other electronic devices, including mobile devices, exponentially increases network requirements when utilizing cloud services, which can cause an increase in latency, potentially resulting in lower quality of service, higher bandwidth costs, etc. Advantageously, edge computing can assist in alleviating these issues.

Multi-access edge computing (MEC) provides a computing approach where one or more aspects of selected cloud-computing capabilities in an information technology (IT) service environment are provided at the edge of a network. MEC provides an ecosystem in which applications and services can be flexibly and rapidly deployed.

In cellular communication, 5G is the next generation of broadband cellular networks, which allow for significantly increased communication rates. MEC has implementations for various networks, and 5G implementations have been expanding as service providers adopt this most current and technology-advanced system for customers. When combined, MEC and 5G can be a powerful force in the world of computing. The emergence of 5G network capabilities continues to increase with the number of connected devices on a network, which spurs the need for edge computing to help distribute networking demands. Applications that rely heavily on a consistent network connection, rapid deployment, and low latency include burgeoning technologies such as artificial intelligence (AI), IoT, virtual reality (VR), augmented reality (AR), etc. MEC and 5G networking together allow for simultaneous usage of a massive number of connected technologies without incurring network outages due to traffic bottlenecks.

### SUMMARY

Certain shortcomings of the prior art are overcome, and additional advantages are provided herein through the provision of a computer-implemented method which includes predicting, via data analytics, edge condition development for a network edge controller of a network, where the network includes a plurality of network edge controllers with respective edge conditions. Further, the computer-implemented method includes determining, based on the predicting, that code governing one or more edge operations at the network edge controller can be optimized for the predicted edge condition development, and obtaining, based on the determining, optimized code to replace the code governing the one or more edge operations of the network edge controller. The optimized code optimizes the one or more edge operations at the network edge controller for the predicted edge condition development. Further, the computer-implemented method includes transmitting the optimized code to the network edge controller for deployment, to optimize the one or more edge operations at the network edge controller based on the predicted edge condition development.

Computer program products and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the disclosed inventive aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1A depicts one example of a computing environment to include and/or use one or more aspects of the present disclosure;

FIG. 1B depicts another example of a computing environment to include and/or use one or more aspects of the present disclosure;

FIG. 2 depicts one embodiment of a computer program product with an edge-controller-code optimization tool, in accordance with one or more aspects of the present disclosure;

FIG. 3 depicts one embodiment of an edge-controller-code optimization process, in accordance with one or more aspects of the present disclosure;

FIG. 4A depicts one embodiment of a cellular network with edge-based computing, which is to implement edge-controller-code optimization code and processing, in accordance with one or more aspects of the present disclosure;

FIG. 4B depicts one embodiment of edge computing at an edge site of a cellular network such as depicted in FIG. 4A, which is to utilize optimized code for governing one or more edge operations at the network edge controller based on predicted edge condition development for the network edge controller, in accordance with one or more aspects of the present disclosure;

FIG. 5 depicts an exemplary embodiment of a cellular network with edge-based computing with diverse respective conditions at different network edge controllers, or edge orchestrators, of the network, in accordance with one or more aspects of the present disclosure;

FIGS. 6A-6B depict an exemplary embodiment of optimizing code covering one or more edge operations at a network edge controller based on predicted edge condition development at the network edge controller, in accordance with one or more aspects of the present disclosure;

FIG. 7 depicts a further embodiment of an edge-controller-code optimization workflow, in accordance with one or more aspects of the present disclosure;

FIG. 8A depicts an exemplary embodiment of predicting, via data analytics, edge condition development at a network edge controller, and optimizing the relevant code based on the predicted edge condition development, in accordance with one or more aspects of the present disclosure;

FIG. 8B depicts an example of predicted edge condition development at a network edge controller of a network, in accordance with one or more aspects of the present disclosure; and

FIG. 8C depicts an exemplary embodiment of generating an optimized code and validating the optimized code to optimize one or more edge operations at a network edge controller, in accordance with one or more aspects of the present disclosure.

### DETAILED DESCRIPTION

In one or more aspects, disclosed herein is a computer-implemented method which includes predicting, via data analytics, edge condition development for a network edge controller of a network, where the network includes a plurality of network edge controllers with respective edge conditions. Further, the computer-implemented method includes determining, based on the predicting, that code governing one or more edge operations at the network edge controller can be optimized for the predicted edge condition development, and obtaining, based on the determining, optimized code to replace the code governing the one or more edge operations of the network edge controller. The optimized code optimizes the one or more edge operations at the network edge controller for the predicted edge condition development. Further, the computer-implemented method includes transmitting the optimized code to the network edge controller for deployment, to optimize the one or more edge operations at the network edge controller based on the predicted edge condition development. Advantageously, the computer-implemented method facilitates processing by, for instance, improving edge computing in a network by reconfiguring and optimizing code governing one or more network edge operations at a network edge controller of the network for one or more predicted edge conditions to develop at that edge controller. Optimizing the code governing edge operations at the network edge controller can be directed to one or more predicted conditions including, for instance, one or more predicted user conditions, one or more predicted network conditions, one or more predicted utilization conditions, one or more predicted service requirements, etc. By obtaining the optimized code, and providing the optimized code to the network edge controller for deployment, the code covering one or more edge operations at the network edge controller is dynamically tailored or reconfigured for the particular predicted edge condition development to occur at that edge controller. In this manner, processing within the network environment is improved by, for instance, reducing memory usage and/or improving execution speed at one or more edge controllers of the network through deploying of respective optimized code.

In embodiments, obtaining the optimized code includes generating, via generative artificial intelligence re-coding of the code, the optimized code to replace the code governing the one or more edge operations at the network edge controller to optimize the one or more edge operations at the network edge controller for the predicted edge condition development. Generating, via generative artificial intelligence re-coding of the code, the optimized code advantageously integrates generative artificial intelligence into operation of the network to enhance processing within the network environment by, for instance, reducing memory usage and/or improving execution speed in one or more edge controllers of the network through deploying of optimized code for that network edge controller based on the predicted edge condition development. Use of generative artificial intelligence re-coding of the code facilitates dynamic tailoring and optimization of the code for a particular network edge controller based on the predicted edge condition development for that network edge controller.

In embodiments, the method further includes validating the optimized code using one or more validation data sets as input, where the validating is prior to deploying the optimized code on the network edge controller. Validating the optimized code prior to deploying the optimized code on the network edge controller ensures correct operation of optimized code prior to deployment, thereby facilitating edge computing in the network through the validated, optimized code governing one or more edge operations at the network edge controller.

In embodiments, the code is code selected from the group consisting of artificial intelligence-based code and machine learning-based code. Advantageously, the method adapts artificial intelligence-based code and/or machine learning-based code of the network edge controller for the predicted edge condition development of that network edge controller. In one or more embodiments, the artificial intelligence-based code or machine learning-based code is deployed on the network edge controller to govern one or more network edge operations at the network edge controller, and processing is enhanced by, for instance, selectively removing a code segment, modifying a code segment, and/or adding a code segment to the code (based on the predicted edge condition development) that the network edge controller utilizes for the network to function, thereby optimizing performance of the network. In one or more implementations, the artificial intelligence-based code or machine learning-based code facilitates network operation of one or more applications running at the respective edge site of the network.

In embodiments, the method further includes identifying, based on the predicted edge condition development for the network edge controller, a point in time for optimizing the code by replacing the code with the optimized code at the network edge controller. Identifying, based on the predicted edge condition development for the network edge controller, the point in time for optimizing the code by replacing the code with the optimized code advantageously optimizes performance of the network edge controller at that point in time. In this manner, processing within the network environment is improved by, for instance, reducing memory usage and/or improving execution speed at the network edge controller at the identified point in time.

In embodiments, the method further includes deploying the optimized code at the network edge controller at the identified point in time to dynamically optimize the one or more edge operations at the network edge controller based on the predicted edge condition development. Processing within the network is improved by dynamically optimizing the one or more edge operations at the network edge controller based on the predicted edge condition development through deploying the optimized code at the network edge controller at the identified point in time, thereby improving, for instance, memory usage and/or execution speed at the edge controller for the predicted edge condition development.

In embodiments, predicting the edge condition development for the network edge controller includes predicting, via data analytics, user plane condition development for the network edge controller of the network. Predicting, via data analytics, user plane condition development for the network edge controller, and obtaining the optimized code to replace the code governing the one or more edge operations based thereon, advantageously optimizes the code governing one or more edge operations at the network edge controller based on predicted changing user plane conditions at that edge controller. In this manner, the code governing one or more edge operations at the network edge controller is dynamically reconfigured and optimized for the predicted changes, such as predicted changes in user patterns, or predicted changes in network patterns over a period of time.

In embodiments, the network edge controller includes an edge-based, radio access network (RAN) intelligent controller, and the one or more edge operations at the network edge controller are one or more network operations at the network edge controller. Advantageously, processing at the network edge controller, or edge-based radio access network (RAN) intelligent controller, is optimized for one or more network operations, and in particular, is optimized for processing functioning in a specific context, that is, for the predicted edge condition development at the edge controller.

In embodiments, the predicting, the determining, the obtaining and the transmitting are by a non-edge-based controller of the network, where the non-edge-based controller performs the predicting, the determining, the obtaining and the transmitting for multiple network edge controllers of the plurality of network edge controllers of the network, and where the obtained optimization code for at least two network edge controllers of the multiple network edge controllers is different. In this manner, code governing one or more edge operations at the network edge controller is optimized within the network at different edge controllers of the network for diverse edge conditions, where two or more network edge controllers have different optimized code based on their respective predicted edge condition development. This advantageously expands code governing one or more edge operations within the network beyond a one size fits all approach, by providing tailored and optimized code for diverse edge conditions within the network, thereby providing more efficient utilization of resources within the network.

In another aspect, a computer program product is provided which includes a set of one or more computer-readable storage media, and program instructions collectively stored in the set of one or more storage media, for causing at least one processor to perform computer operations. The computer operations include predicting, via data analytics, edge conditioned development for a network edge controller of a network, where the network includes a plurality of network edge controllers with respective edge conditions. Further, the computer operations include determining, based on the predicting, that code governing one or more edge operations at the network edge controller can be optimized for the predicted edge condition development and obtaining, based on determining, optimized code to replace the code governing the one or more edge operations at the network edge controller. The optimized code optimizes the one or more edge operations at the network edge controller for the predicted edge condition development. Further, the computer operations include transmitting the optimized code to the network edge controller for deployment to optimize the one or more edge operations at the network edge controller based on the predicted edge condition development. Advantageously, the computer operations facilitate processing by, for instance, improving edge computing in a network by reconfiguring and optimizing code governing one or more network edge operations at a network edge controller of the network for one or more predicted edge conditions to develop at that edge controller. Optimizing the code governing edge operations at the network edge controller can be directed to one or more predicted conditions including, for instance, one or more predicted user conditions, one or more predicted network conditions, one or more predicted utilization conditions, one or more predicted service requirements, etc. By obtaining the optimized code, and providing the optimized code to the network edge controller for deployment, the code covering one or more edge operations at the network edge controller is dynamically tailored or reconfigured for the particular predicted edge condition development to occur at that edge controller. In this manner, processing within the network environment is improved by, for instance, reducing memory usage and/or improving execution speed at one or more edge controllers of the network through deploying of respective optimized code.

In computer program product embodiments, the obtaining the optimized code includes generating, via generative artificial intelligence re-coding of the code, the optimized code to replace the code governing the one or more edge operations at the network edge controller to optimize the one or more edge operations at the network edge controller for the predicted edge condition development. Generating, via generative artificial intelligence re-coding of the code, the optimized code advantageously integrates generative artificial intelligence into operation of the network to enhance processing within the network environment by, for instance, reducing memory usage and/or improving execution speed in one or more edge controllers of the network through deploying of optimized code for that network edge controller based on the predicted edge condition development. Use of generative artificial intelligence re-coding of the code facilitates dynamic tailoring and optimization of code for a particular network edge controller based on the predicted edge condition development for that network edge controller.

In computer program product embodiments, computer operations further include validating the optimized code using one or more validation data sets as input, where the validating occurs prior to deployment of the optimized code on the network edge controller. Validating the optimized code prior to deploying the optimized code on the network edge controller ensures correct operation of optimized code prior to deployment, thereby facilitating edge computing in the network through the validated, optimized code governing one or more edge operations at the network edge controller.

In computer program product embodiments, the code is selected from the group consisting of artificial intelligence-based code and machine learning-based code. Advantageously, the operations adapt artificial intelligence-based code and/or machine learning-based code of the network edge controller to the predicted edge condition development of that network edge controller. In one or more embodiments, the artificial intelligence-based code or machine learning-based code is deployed on the network edge controller to govern one or more network edge operations at the network edge controller, and processing is enhanced by, for instance, selectively removing a code segment, modifying a code segment, and/or adding a code segment to code (based on the predicted edge condition development) that the network edge controller utilizes for the network to function, thereby optimizing performance of the network. In one or more implementations, the artificial intelligence-based code or machine learning-based code facilitates operation of one or more applications running at the respective edge site of the network.

In computer program product embodiments, the computer operations further include identifying, based on predicted edge condition development for the network edge controller, a point in time for optimizing the code by replacing the code with the optimized code at the network edge controller, and deploying the optimized code at the network edge controller at the identified point in time to dynamically optimize edge operations at the network edge controller based on the predicted edge condition development. Identifying, based on the predicted edge condition development for the network edge controller, the point in time for optimizing the code by replacing the code with the optimized code advantageously optimizes performance of the network edge controller at that point in time. In this manner, processing within the network environment is improved by, for instance, reducing memory usage and/or improving execution speed at the network edge controller at the identified point in time. Processing within the network is improved by dynamically optimizing the one or more edge operations at the network edge controller based on the predicted edge condition development through deploying the optimized code at the network edge controller at the identified point in time, thereby improving, for instance, memory usage and/or execution speed at the edge controller for the predicted edge condition development.

In computer program product embodiments, predicting the edge condition development for the network edge controller includes predicting, via data analytics, user plane condition development for the network edge controller of the network, where the network edge controller includes an edge-based radio access network (RAN) intelligent controller, and where the one or more edge operations at the network edge controller are one or more network operations at the network edge controller. Predicting, via dynamic analytics, user plane condition development for the network edge controller, and obtaining the optimized code to replace the code governing the one or more edge operations based thereon advantageously optimizes the code governing one or more edge operations at the network edge controller based on the predicted changing user plane conditions at that edge controller. In this manner, the code governing one or more edge operations at the network edge controller is dynamically reconfigured and optimized for the predicted changes, such as predicted changes in user patterns, or predicted changes in network patterns over a period of time. Advantageously, processing at the network edge controller, or edge-based radio access network (RAN) intelligent controller, is optimized for one or more network operations, and in particular, is optimized for processing functioning in a specific context, that is, for the predicted edge condition development at the edge controller.

In computer program product embodiments, the predicting, the determining, the obtaining and the transmitting are by a non-edge-based controller of the network, where the non-edge-based controller performs the predicting, the determining, the obtaining and the transmitting for multiple network edge controllers of the plurality of network edge controllers and where the obtained optimized code for at least two network edge controllers of the multiple network edge controllers is different. In this manner, code governing one or more edge operations at the network edge controller is optimized within the network at different edge controllers of the network for diverse edge conditions, where two or more network edge controllers have different optimized code based on their respective predicted edge condition development. This advantageously expands code governing one or more edge operations within the network beyond a one size fits all approach, by providing tailored and optimized code for diverse edge conditions within the network, thereby providing more efficient utilization of resources within the network.

In a further aspect, a computer system is provided which includes at least one processor set, a set of one or more computer-readable storage media, and program instructions, collectively stored in the set of one or more storage media, for causing the at least one processor set to perform computer operations. The computer operations include predicting, via data analytics, edge condition development for a network edge controller of a network, where the network includes a plurality of network edge controllers with respective edge conditions. Further, the computer operations include determining, based on the predicting, that code governing one or more edge operations at the network edge controller can be optimized for the predicted edge condition development, and obtaining, based on the determining, optimized code to replace the code governing the one or more edge operations at the network edge controller. The optimized code optimizes the one or more edge operations at the network edge controller for the predicted edge condition development. Further, the computer operations include transmitting the optimized code to the network edge controller for deployment to optimize the one or more edge operations at the network edge controller based on the predicted edge condition development. Advantageously, the computer-implemented method facilitates processing by, for instance, improving edge computing in a network by reconfiguring and optimizing code governing one or more network edge operations at a network edge controller of the network for one or more predicted edge conditions to develop at that edge controller. Optimizing the code governing edge operations at the network edge controller can be directed to one or more predicted conditions including, for instance, one or more predicted user conditions, one or more predicted network conditions, one or more predicted utilization conditions, one or more predicted service requirements, etc. By obtaining the optimized code, and providing the optimized code to the network edge controller for deployment, the code covering one or more edge operations at the network edge controller is dynamically tailored or reconfigured for the particular predicted edge condition development to occur at that edge controller. In this manner, processing within the network environment is improved by, for instance, reducing memory usage and/or improving execution speed at one or more edge controllers of the network through deploying of respective optimized code.

In computer system embodiments, obtaining the optimized code includes generating, via generative artificial intelligence re-coding of the code, the optimized code to replace the code governing the one or more edge operations at the network edge controller to optimize the one or more edge operations at the network edge controller for the predicted edge condition development, and the computer operations further include validating the optimized code using one or more validation data sets as input, where the validating is prior to deploying the optimized code on the network edge controller. Generating, via generative artificial intelligence re-coding of the code, the optimized code advantageously integrates generative artificial intelligence into operation of the network to enhance processing within the network environment by, for instance, reducing memory usage and/or improving execution speed in one or more edge controllers of the network through deploying of optimized code for that network edge controller based on the predicted edge condition development. Use of generative artificial intelligence re-coding of the code facilitates dynamic tailoring and optimization of the code for a particular network edge controller based on the predicted edge condition development for that network edge controller. Validating the optimized code prior to deploying the optimized code on the network edge controller ensures correct operation of optimized code prior to deployment, thereby facilitating edge computing in the network through the validated, optimized code governing one or more edge operations at the network edge controller.

In computer system embodiments, the code is selected from the group consisting of artificial intelligence-based code and machine learning-based code. Advantageously, the computer operations adapt the artificial intelligence-based code and/or machine learning-based code of the network edge controller for the predicted edge condition development of that network edge controller. In one or more embodiments, the artificial intelligence-based code or machine learning-based code is deployed on the network edge controller to govern one or more network edge operations at the network edge controller, and processing is enhanced by, for instance, selectively removing a code segment, modifying a code segment, and/or adding a code segment to the code (based on the predicted edge condition development) that the network edge controller utilizes for the network to function, thereby optimizing performance of the network. In one or more implementations, the artificial intelligence-based code or machine learning-based code facilitates network operation of one or more applications running at the respective edge site of the network.

In computer system embodiments, predicting the edge condition development for the network edge controller includes predicting, via data analytics, user plane condition development for the network edge controller of the network, and where the network edge controller includes an edge-based radio access network (RAN) intelligent controller, and the one or more edge operations at the network edge controller are one or more network operations at the network edge controller. Predicting, via data analytics, user plane condition development for the network edge controller, and obtaining the optimized code to replace the code governing the one or more edge operations based thereon, advantageously optimizes the code governing the one or more edge operations at the network edge controller based on the predicted changing user plane conditions at that edge controller. In this manner, the code governing one or more edge operations at the network edge controller is dynamically reconfigured and optimized for the predicted changes, such as predicted changes in user patterns, or predicted changes in network patterns over a period of time. Further, processing at the network edge controller, or edge-based radio access network (RAN) intelligent controller, is optimized for one or more network operations, and in particular, is optimized for processing functioning in a specific context, that is, for the predicted edge condition development at the edge controller.

In one or more further embodiments, a computer-implemented method is disclosed which includes predicting, via data analytics, edge condition development for a network edge controller of a network, where the network includes a plurality of edge controllers with respective edge conditions. Further, the computer-implemented method includes determining, based on the predicting, that code governing one or more edge operations at the network edge controller can be optimized for the predicted edge condition development, and obtaining, based on determining, optimized code to replace the code governing the one or more edge operations of the network edge controller. The optimized code optimizes the one or more edge operations of the network edge controller for the predicted edge condition development. Further, the computer-implemented method includes transmitting the optimized code to the network edge controller for deployment, to optimize the one or more edge operations at the network edge controller based on the predicted edge condition development. Obtaining the optimized code includes generating, via generative artificial intelligence re-coding of the code, the optimized code to replace the code governing the one or more edge operations at the network edge controller to optimize the one or more edge operations at the network edge controller for the predicted edge condition development. In addition, predicting the edge condition development for the network edge controller includes predicting, via data analytics, user plane condition development for the network edge controller of the network, where the network edge controller includes an edge-based radio access network (RAN) intelligent controller, and the one or more edge operations at the network edge controller include one or more network operations at the network edge controller. Advantageously, the computer-implemented method facilitates processing by, for instance, improving edge computing in a network by reconfiguring and optimizing code governing one or more network edge operations at a network edge controller of the network for one or more predicted edge conditions to develop at that edge controller. In this manner, processing within the network environment is improved by, for instance, reducing memory usage and/or improving execution speed at one or more edge controllers of the network through deploying of respective optimized code. Further, generating, via generative artificial intelligence re-coding of the code, the optimized code advantageously integrates generative artificial intelligence into operation of the network to enhance processing within the network environment by, for instance, reducing memory usage and/or improving execution speed in one or more edge controllers of the network through deploying of optimized code for that network edge controller based on the predicted edge condition development. In addition, predicting, via data analytics, user plane condition development for the network edge controller, and obtaining the optimized code to replace the code governing the one or more edge operations based thereon, advantageously optimizes the code governing the one or more edge operations at the network edge controller based on predicted changing user plane conditions at that edge controller. In this manner, processing at the network edge controller, or edge-based radio access network (RAN) intelligent controller is optimized for one or more network operations and in particular, is optimized for processing functioning in a specific context, that is, the predicted edge condition development at the edge controller.

In further embodiments, the predicting, the determining, the obtaining and the transmitting are by a non-edge-based controller of the network, with the non-edge-based controller performing the predicting, the determining, the obtaining and the transmitting for multiple network edge controllers of the plurality of network edge controllers, where the obtained optimized code for at least two network edge controllers of the multiple network edge controllers is different. In this manner, code governing one or more edge operations at the network edge controller is optimized within the network at different edge controllers of the network for diverse edge conditions, where two or more network edge controllers have different optimized code based on their respective predicted edge condition development. This advantageously expands code governing one or more edge operations within the network beyond a one size fits all approach, by providing tailored and optimized code for diverse edge conditions within the network, thereby providing more efficient utilization of resources within the network.

In an additional embodiment, a computer-implemented method is disclosed, which includes predicting, via data analytics, edge condition development for a network edge controller of a network, where the network includes a plurality of network edge controllers with respective edge conditions. Further, the computer-implemented method includes determining, based on the predicting, that code governing one or more edge operations at the network edge controller can be optimized for the predicted edge condition development, and obtaining, based on the determining, optimized code to replace the code governing the one or more edge operations of the network edge controller. The optimized code optimizes the one or more edge operations at the network edge controller for the predicted edge condition development. Further, the computer-implemented method includes transmitting the optimized code to the network edge controller for deployment, to optimize the one or more edge operations at the network edge-controller-based on the predicted edge condition development. In the additional embodiments, the code is selected from the group consisting of artificial intelligence-based code and machine learning-based code, and predicting the edge condition development for the network edge controller includes predicting, via data analytics, user plane condition development for the network edge controller of the network. Further, in additional embodiments, the network edge controller includes an edge-based radio access network (RAN) intelligent controller, and the one or more edge operations at the network edge controller include one or more network operations at the network edge controller. Advantageously, the computer-implemented method facilitates processing by, for instance, improving edge computing in a network by reconfiguring and optimizing code governing one or more network edge operations at a network edge controller of the network for one or more predicted edge conditions to develop at that edge controller. In this manner, processing within the network environment is improved by, for instance, reducing memory usage and/or improving execution speed at one or more edge controllers of the network through deploying of respective optimized code. Advantageously, the additional embodiments adapt artificial intelligence-based code and/or a machine learning-based code of the network edge controller for the predicted edge condition development of that network edge controller. In one or more embodiments, the artificial intelligence-based code or machine learning-based code is deployed on the network edge controller to govern one or more network edge operations at the network edge controller, and processing is enhanced by, for instance, selectively removing a code segment, modifying a code segment and/or adding a code segment to the code (based on the predicted edge condition development) that the network edge controller utilizes for the network to function, thereby optimizing performance of the network. Further, predicting via data analytics, user plane condition development for the network edge controller, and obtaining the optimized code to replace the code governing the one or more edge operations based thereon, advantageously optimizes the code governing the one or more edge operations at the network edge-controller-based on predicted changing user plane conditions at that edge controller. Processing at the network edge controller, or edge-based radio access network (RAN) intelligent controller, is optimized for one or more network operations, and in particular, is optimized for processing functioning in a specific context, that is, for the predicted edge condition development at the edge controller.

In the additional embodiments, the predicting, the determining, the obtaining and the transmitting are by a non-edge-based controller of the network, where the non-edge-based controller performs the predicting, the determining, the obtaining and the transmitting for multiple network edge controllers of the plurality of network edge controllers of the network and where the obtained optimization code for at least two network edge controllers of the multiple network edge controllers is different. In this manner, code governing one or more edge operations at the network edge controller is optimized within the network at different edge controllers of the network for diverse edge conditions, where two or more network edge controllers have different optimized code based on their respective predicted edge condition development. This advantageously expands code governing one or more edge operations within the network beyond a one size fits all approach, providing tailored and optimized code for diverse edge conditions within the network, thereby providing more efficient utilization and resources within the network.

Aspects of the present disclosure and certain features, advantages, and details thereof, are explained more fully below with reference to the non-limiting example(s) illustrated in the accompanying drawings. Descriptions of well-known software, systems, devices, processing techniques, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative embodiment can be implemented in software, hardware, or a combination thereof.

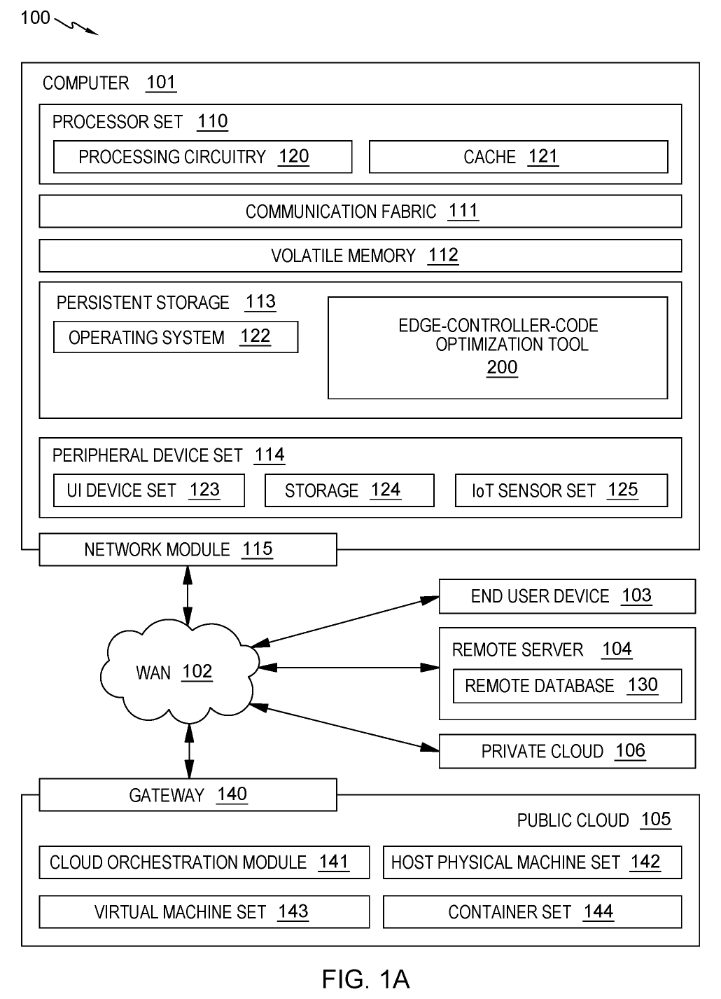

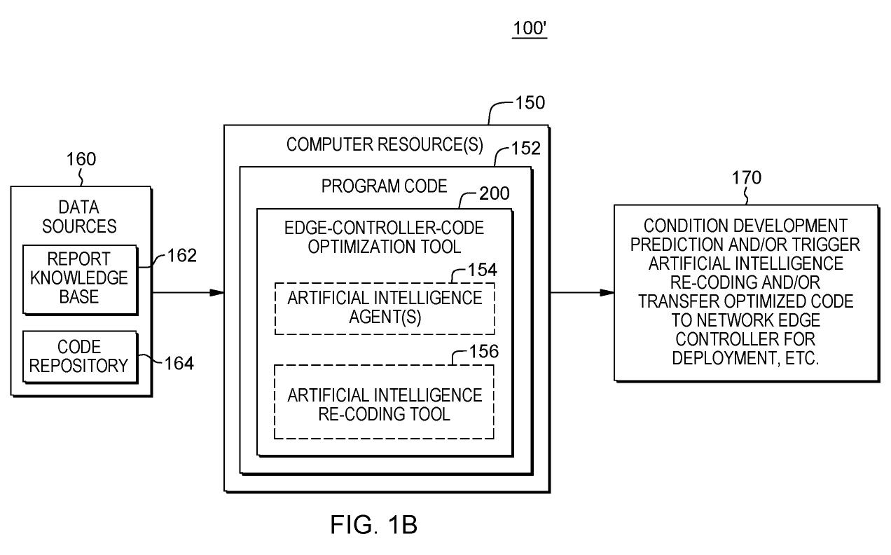

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1A, including operating system 122 and edge-controller-code optimization tool 200, which are stored in persistent storage 113.

In one or more aspects, a computer-implemented method, computer program product and computer system are provided herein to facilitate processing within a network environment, and in particular to improve edge computing in a network, such as a cellular network, by dynamically optimizing network edge-controller-code for one or more predicted future edge conditions. In one or more embodiments, edge-controller-code governing one or more edge operations (e.g., one or more network edge operations) is dynamically reconfigured and optimized for a predicted edge condition(s) at the edge controller. Further, in one or more embodiments, a particular edge-controller-code can be differently tailored, or optimized, for different network edge controllers of a network which are predicted to experience different respective edge conditions in the network.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1A, computing environment 100 contains an example of an environment for the execution of at least some of the computer code involved in performing the inventive methods, such as edge-controller-code optimization tool or block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1A. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1A need not be included in the computing environment and/or are not used for one or more aspects of the present disclosure. Further, in one or more embodiments, additional and/or other components/modules can be used. Other variations are possible.

By way of further example, FIG. 1B depicts another embodiment of a computing environment 100′, which can incorporate, use or implement, one or more aspects of an embodiment of the present disclosure. In one or more embodiments, computing environment 100′ is implemented as part of, or includes, a computing environment such as computing environment 100 described above in connection with FIG. 1A. Computing environment 100′ contains one or more computer resources 150, such as one or more computers 101 of FIG. 1A, connected to receive (e.g., obtain, access, etc.) data from one or more data sources 160, such as a report knowledge base 162 and a code repository 164. In one or more embodiments, the report knowledge base 162 is a database which includes, for instance, control plane data and/or user plane data generated at, or for, respective network edge controllers regarding one or more observed network edge conditions at that controller or edge site. In one or more embodiments, code repository 164 can include one or more source codes to execute on one or more network edge controllers to govern, for instance, one or more edge operations (or network edge operations) of the respective network edge controller. For instance, in one or more embodiments, the source code can be artificial intelligence-based code or machine learning-based code governing one or more network edge operations, such that the code repository, in one implementation, is an artificial intelligence/machine learning code repository. In one specific example, the source codes govern, or specify, available network spectrums, such as for use by one or more applications.

In one or more embodiments, the one or more computer resources 150 execute program code 152 that implements, for instance, one or more aspects of edge-controller-code optimization tool 200, such as disclosed herein. In one or more embodiments, edge-controller-code optimization tool 200 includes, or utilizes, one or more artificial intelligence (AI) agents 154, which can be part of edge-controller-code optimization tool 200 or accessed by edge-controller-code optimization tool 200. Edge-controller-code optimization tool 200 facilitates dynamically tailoring and optimizing edge-controller-code governing one or more network operations at a particular edge site. In one or more embodiments, this can include predicting, via a data analytics, by an artificial intelligence agent, edge condition development for a network edge controller of a network, and determining based on the predicting, that code covering one or more edge operations at the network edge controller can be optimized for the predicted edge condition development at that edge controller. Further, the optimization tool obtains, based on the determining, optimized code to replace the code governing the one or more edge operations at the network edge controller. The optimized code optimizes the one or more edge operations at the network edge controller for the predicted edge condition development. For instance, in one or more embodiments, obtaining the optimized code includes generating, via artificial intelligence re-coding 156, the optimized code to replace the code governing the one or more edge operations at the network edge controller, and thereby dynamically optimize edge operations at the edge controller for the predicted edge condition development. In embodiments, edge-controller-code optimization tool 200 provides one or more predictions, optimized code and/or transfers optimized code to a network edge controller for deployment, etc. 170. For instance, in one or more embodiments, edge-controller-code optimization tool 200 predicts, via data analytics, edge condition development for a network edge controller of the network and determines, based on a predicting, that code governing one or more edge operations in a network edge controller can be optimized for the predicted edge condition development. Further, the edge-controller-code optimization tool 200 can trigger generative artificial intelligence re-coding of the code to obtain a re-configured optimized code that optimizes, when deployed, one or more edge operations of the network edge controller for the predicted edge condition development. In one or more embodiments, the edge-controller-code optimization tool 200 transfers or transmits the optimized code 170 to the network edge controller for deployment to optimize edge operations at the network edge controller based on the predicted edge condition development.

In one or more implementations, computing environment 100′ can include, or utilize, one or more networks for interfacing various aspects of computing resource(s) 150, as well as one of or more other controllers, components, systems, etc., receiving a result, optimized code, action instruction, etc. 170 of the edge-controller-code optimization tool 200 in a manner that facilitates processing of data within the computing environment. By way of example, the network(s) can be, for instance, a telecommunications network, a local area network (LAN), a wide area network (WAN), such as the Internet, or a combination thereof, and can include wired, wireless, fiber optic connections, etc. The network(s) can include one or more wired and/or wireless networks that are capable of receiving and transmitting data, including training data for one or more artificial intelligence (AI) agents of the edge-controller-code optimization tool, and an output solution, recommendation, action of the edge-controller-code optimization tool, such discussed herein.

In one or more implementations, computer resource(s) 150 house and/or execute program code 152 configured to perform computer-implemented methods in accordance with one or more aspects of the present disclosure. By way of example, computer resource(s) 150 can be a computing-system-implemented resource(s). Further, for illustrative purposes only, computing resource(s) 150 in FIG. 1B is depicted as being a single computer resource. This is a non-limiting example of an implementation. In one or more other embodiments, computer resource(s) 150, which implements one or more aspects of processing such as discussed herein, can, at least in part, be implemented in multiple separate computer resources or systems, such as one or more computer resources of a cloud-hosting environment, by way of example.

Briefly described, in one embodiment, computer resource(s) 150 can include one or more processor sets with one or more processors, for instance, central processing units (CPUs). Also, the processor set(s) can include functional components used in the integration of program code, such as functional components to fetch program code from locations in memory, such as cache or main memory, decode program code, and execute program code, access memory for instruction execution, and write results of the executed instructions or code. The processor set(s) can also include a register(s) to be used by one or more of the functional components. In one or more embodiments, the computing resource(s) can include memory, input/output, a network interface, and storage, which can include and/or access, one or more other computing resources and/or databases, as required to implement the edge-controller-code optimization tool processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computer resource(s), or computing system(s) or controller(s), which can implement one or more aspects disclosed are described further herein.

In one or more embodiments, program code 152 includes, executes, accesses, etc., one or more artificial intelligence agents 154 which (in one or more embodiments) can train and/or use one or more machine learning models that embody (in part), or are used by, the edge-controller-code optimization tool 200. Further, in one or more embodiments, program code 152 includes, executes, accesses, initiates, communicates with, etc., one or more regenerative artificial intelligence re-coding tools 156 (such as an available, generative artificial intelligence re-coding tool(s)) which, in one or more embodiments, are configured to optimize source code governing one or more edge operations (or network edge operations) at a network edge controller of the network. The code can be optimized in a variety of aspects, such as by, for instance, omitting, adding, modifying one or more code aspects or segments of the code governing one or more edge operations at the network edge controller, such as available network spectrum, as described further herein. The artificial intelligence agent(s) and artificial intelligence re-coding tool can be existing artificial intelligence agents or existing tools and/or can include, or use, one or more machine learning models that can be pretrained using training data that can include a variety of types of data or datastreams. In one or more embodiments, program code 152 executing on one or more computer resources 150 applies one or more algorithms of, for instance, the artificial intelligence agent(s) 154 to generate and train the model(s), which the program code then utilizes to, for instance, implement one or more aspects of edge-controller-code optimization tool 200. In an initialization or learning stage, program code 152 can train one or more machine learning models using obtained training data to implement, for instance, one or more aspects of the code, functions, modules and/or tools described herein.

Data used to train the models (in one or more embodiments of the present disclosure) can include a variety of types of data, such as edge condition data in one or more report knowledge bases 162, and the code or source code at issue governing one or more edge operations at the network edge controller. Program code, in embodiments of the present disclosure, can perform data analysis to generate data structures, including algorithms utilized by the program code to implement one or more aspects of the edge-controller-code optimization tool and/or initiate (or perform) an action related thereto. As known, machine learning-based modeling solves problems that cannot be solved by numerical means alone. In one example, program code extracts features/attributes from the training data, which can be stored in memory or one or more databases. The extracted features can be utilized to develop a predictor function, h(x), also referred to as a hypothesis, which the program code utilizes as a model. In identifying machine learning model(s), various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weigh various attributes (e.g., features, patterns) that correlate to enhanced performance of the model.

In one or more embodiments, program code, executing on one or more processors, utilizes one or more artificial intelligence agents (now known or later developed) and/or one or more generative artificial intelligence re-coding tools (now know or later developed) to facilitate implementing one or more aspects disclosed herein. In one or more embodiments, the program code can interface with application programming interfaces to perform a cognitive analysis of obtained and/or converted data or code. Specifically, in one or more embodiments, certain application programing interfaces include a cognitive agent (e.g., learning agent) that includes one or more programs, including, but not limited to, natural language classifiers, a retrieve-and-rank service that can surface the most relevant information, concepts/visual insights, tradeoff analytics, document conversion, and/or relationship extraction. In an embodiment, one or more programs analyze the data obtained by the program code from one or more sources utilizing one or more of a natural language classifier, retrieve-and-rank application programming interfaces, and tradeoff analytics application programing interfaces, etc.

In one or more embodiments, the program code can utilize one or more neural networks (NNs) to analyze training data and/or collected data and/or source code to generate, for instance, one or more operational machine learning models. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present disclosure, can utilize in implementing an edge-controller-code optimization, such as described herein.

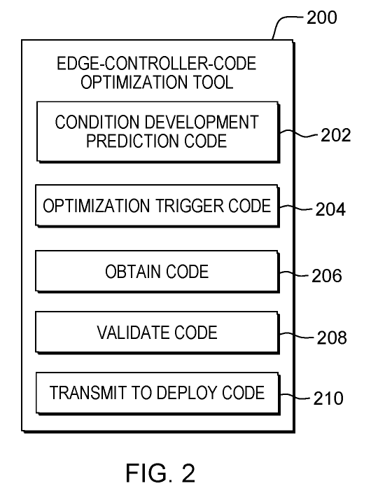

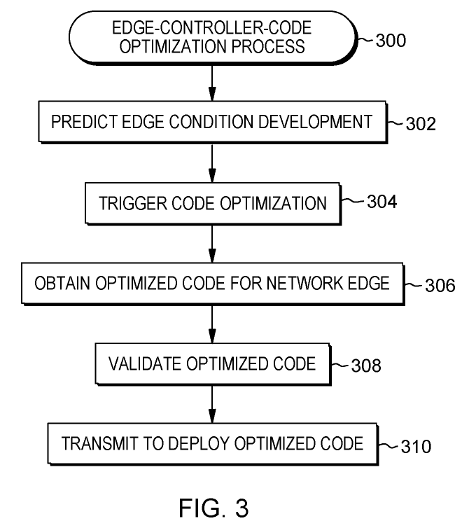

By way of example, one or more embodiments of an edge-controller-code optimization tool and workflow are described initially with reference to FIGS. 2-3. FIG. 2 depicts one embodiment of an edge-controller-code optimization tool or module 200 that includes code or instructions to perform edge-controller-code optimization, in accordance with one or more aspects of the present disclosure, and FIG. 3 depicts one embodiment of an edge-controller-code optimization tool workflow, in accordance with one or more aspects of the present disclosure.

Referring to FIGS. 1A-2, edge-controller-code optimization tool 200 includes, in one example, various code or sub-modules used to perform processing, in accordance with one or more aspects of the present disclosure. The sub-modules are, e.g., computer-readable program code (e.g., instructions) in computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s)101 and/or computer resource(s) 150 (FIG. 1B); one or more processor sets 110 (FIG. 1A); processors, such as one or more processors of processor set 110; and/or processing circuitry, such as processing circuity of processor set 110, etc.

As noted, FIG. 2 depicts one embodiment of edge-controller-code optimization tool 200 which, in one or more implementations, includes, or facilitates, edge-controller-code optimization processing in accordance with one or more aspects of the present disclosure. In the embodiment of FIG. 2, example code of edge-controller-code optimization tool 200 includes condition development prediction code 202 to predict, via data analytics, edge condition development for a network edge controller of a network. The predicted edge condition development can be one or more predicted edge conditions at the network edge controller or edge site. Further, in one or more embodiments, edge-controller-code optimization tool 200 includes optimization trigger code 204 to, for instance, determine, based on the predicting, that code covering one or more edge operations at the network edge controller can be optimized for the predicted edge condition development, and to trigger optimizing of the code to, for instance, replace the code governing one or more edge operations at the network edge controller based on the predicted edge condition development. In one or more embodiments, edge-controller-code optimization tool 200 further includes obtain code 206 to obtain optimized code to, for instance, replace code governing one or more edge operations at the network edge controller. In one or more embodiments, the optimized code is generated, via generative artificial intelligence re-coding of the code, and the optimized code is configured to replace the code governing one or more edge operations at the network edge controller to optimize the edge operations at the network edge controller for the predicted edge condition development. In one or more embodiments, edge-controller-code optimization tool 200 includes validate code 208 to validate the optimized code using one or more validation data sets as input. In one or more embodiments, the validating is prior to deploying the optimized code on the network edge controller. In one or more embodiments, edge-controller-code optimization tool 200 includes transmit to deploy code 210 to transmit the optimized code to the network edge controller for deployment to optimize edge operations at the network edge controller based on the predicted edge condition development.

Note also that although various code or sub-modules are described herein, an edge-controller-code optimization tool, such as disclosed, can use, or include, additional, fewer, and/or different code/sub-modules. A particular code can include additional code, including code of other sub-modules, or less code. Further, additional and/or fewer code/sub-modules can be used. Many variations are possible.

In one or more embodiments, the edge-controller-code optimization tool is used, in accordance with one or more aspects of the present disclosure, to perform edge-controller-code optimization. FIG. 3 depicts one example of edge-controller-code optimization 300, such as disclosed herein. The process is executed, in one or more embodiments, by a computer (e.g., computer 101 (FIG.1A), computer resource(s) 150 (FIG. 1B)), and/or one or more processor sets, such as a processor or processing circuitry (e.g., of processor set 110 of FIG. 1A). In one example, code or instructions implementing the process, are part of a code or module, such as edge-controller-code optimization tool 200 of FIGS. 1A-2. In other examples, the code can be included in one or more other modules and/or one or more other sub-modules of one or more other modules. Various options are available.

As illustrated in FIG. 3, in one example, edge-controller-code optimization process 300 executing on one or more computers (e.g., computer 101 of FIG. 1A), one or more processor sets (e.g., processor set 110 of FIG. 1A, such as a processor or processing circuitry of the processor set) performs edge-controller-code optimization processing such as described herein, which includes, in one or more embodiments, predicting edge condition development 302. In one or more embodiments, the predicting is via data analytics and the edge condition development is for a network edge controller, or edge orchestrator, at an edge site of a network. In one or more implementations, the network includes a plurality of network edges (such as a plurality of far-end telecommunication edges) each with one or more respective network edge controllers, and each of which can have respective edge conditions associated therewith. In one or more embodiments, the edge-controller-code optimization process 300 further includes trigger code optimization 304, which based on the predicting, determines that code governing one or more edge operations at the network edge controller can be optimized for a predicted edge condition development and as a result, triggers or initiates the optimizing. In one or more embodiments, edge-controller-code optimization process 300 further includes obtaining optimized code for network edge 306. In one or more embodiments, the obtaining is based in determining that the code governing the one or more edge operations can be optimized, and the optimized code is to replace (e.g., delete in part, modify in part, add to in part, etc.) the code governing the one or more edge operations at the network edge controller. The optimized code optimizes one or more edge operations at the network edge controller for the predicted edge condition development. In one or more embodiments, the obtaining can include generating, via generative artificial intelligence re-coding of the code, the optimized code to replace the code governing the one or more edge operations at the network edge controller. In one or more embodiments, edge-controller-code optimization process 300 further includes validating the optimized code 308. Validating the optimized code can use one or more validation data sets as input, and can occur prior to deploying the optimized code on the network edge controller. In one embodiment, the edge-controller-code optimization process further includes transmitting the optimized code to the respective network edge controller for deployment 310. In this manner, the one or more edge operations and the network edge controller are optimized based on the predicted edge condition development. In one or more embodiments, the edge-controller-code optimization process is repeated for multiple, or all, network edge controllers of the network, such that the optimized code is tailored across the network to the particular predicted edge condition developments at the respective edge controllers.

As noted, use of edge-based computing, including edge application services, advantageously reduces the volume of data to be transferred, as well as the subsequent traffic, and distance the data must travel. This results in a lower latency and reduces transmission costs. Computational offloading to the edge (for example, to one or more edge sites of a network, such as of a cellular network), can advantageously benefit response times for real-time applications. In one or more implementations, edge-based containers are used as decentralized computing resources located close to the end-user equipment (e.g., device or system) in order to reduce latency, save bandwidth, and enhance the overall digital experience.

Briefly, containerization is the packaging of software code (for instance, to implement a service or microservice) with its dependencies, such as operating system libraries and/or other dependencies, use to run the software code to create a single, light weight executable, referred to as a container. The container is portable in that it runs consistently and reliably on any information technology infrastructure. In one or more embodiments, the software code can be an application, such as an edge application in the case of edge-based computing. A container is created from a container image, which is a static file that includes executable program code that can be run as an isolated process on a computing or information technology (IT) infrastructure. One image can be used to run one or more containers, which are runtime instances of the container image. Containers are lightweight (e.g., they share the machine’s operating system), efficient, easy to manage, secure and portable.

A number of products are available to automate deployment, scaling and management of containerized applications. In operation, these products can orchestrate a containerized application or code to run on one or more hosts (or nodes), and automate deployment and management of cloud-native applications using on-premise infrastructure or public cloud platforms. The systems are typically designed to run containerized applications across a cluster of nodes (or servers), which can be a single geographical location or distributed across multiple geographical locations, such as at different edge sites of a network computing environment. Container orchestration is the automation of much of the operational effort required to run containerized workloads and services. Orchestration includes a wide range of processes required to maintain a container’s lifecycle, including provisioning, deploying, scaling (up or down), networking, load balancing, and more.

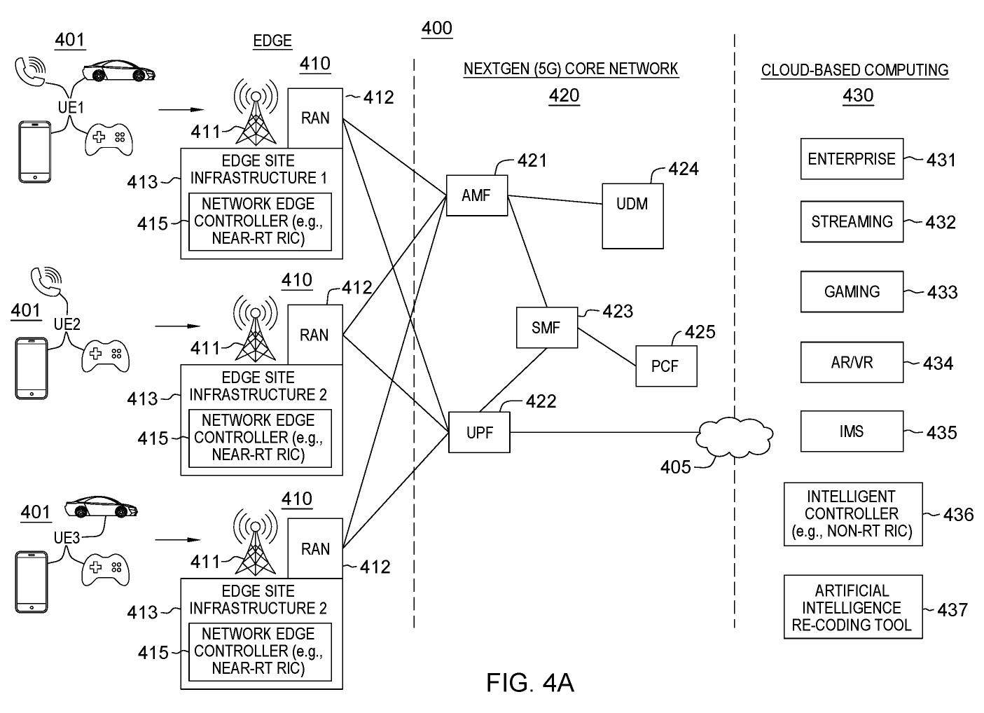

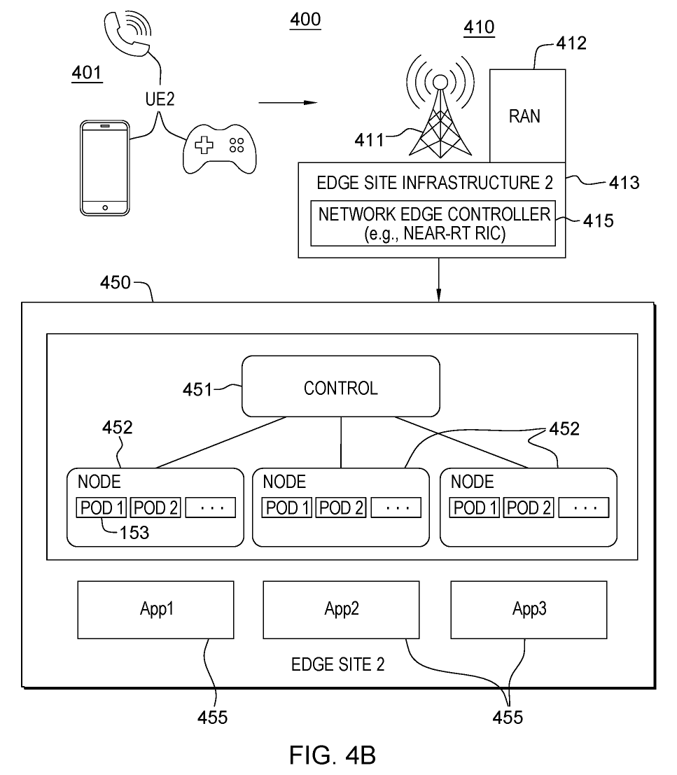

By way of example only, FIG. 4A depicts one embodiment of a next generation cellular network, generally denoted 400. Cellular network 400 includes multiple edge sites 410, each with a respective cell tower 411 for wirelessly interfacing with various types of user equipment 401, UE1, UE2, UE3, within range of the cell tower. In the depicted embodiment, each edge site 410 includes a radio access network 412 interfacing edge site computing infrastructure 413 and (for instance) a next generation (5G) core network 420. In one or more embodiments, the edge site infrastructure 413 and/or radio access network 412 include one or more network edge controllers 415. By way of example only, the one or more network edge controllers can be one or more near-real time radio access network (RAN) intelligent controllers (near-RT RIC), which represent one embodiment of a network edge controller with code governing network edge operations, such as discussed herein. For instance, in one embodiment, the one or more near-RT RICs control radio access network (RAN) resources and elements. The near-RT RIC enables RAN control functionalities, such as radio resource management, quality of service (QoS) control and partitioning or slicing of the RAN.

As illustrated, core network 420 can (in one embodiment) facilitate communication with one or more cloud-based computing resources 430, such as one or more cloud-based computing enterprise applications 431, audio-visual streaming applications 432, gaming applications 433, augmented reality (AR) and/or virtual reality (VR) applications 434, database applications 435, such as an information management system (IMS), etc., one more non-edge-based controllers (such as one or more non-real time radio access network (RAN) intelligent controllers (non-RT RICs) 436 and/or one or more artificial intelligence (AI) re-coding tools 437 (such as artificial intelligence re-coding tool 156 of FIG. 1B), etc. In one or more embodiments, the near-RT RICs receive policy guidance from the non-RT RIC, and provide policy feedback to the non-RT RIC through, for instance, xApps. Further, in one or more embodiments, the non-RT RIC provides policy-based guidance, machine learning model management and enrichment information to the near-RT RICs. The non-RT RIC, in one or more embodiments, creates an inference model from machine learning training and the near-RT RIC performs RAN optimization actions based on the model.

In one embodiment, nextgen core network 420 can include, for instance, a user plane function (UPF) 422, which interfaces the radio access network(s) 412 and a data network 405, such as a local-area network (LAN), a wide-area network (WAN), such as the Internet, or a combination thereof, which can include wired, wireless, fiber-optic connections, etc. The network(s) 405 can include one or more wired and/or wireless networks that are capable of receiving and transmitting data, such as data related to one or more of the applications referenced herein. As further illustrated, an access mobility function (AMF) 421 interfaces, in one embodiment, radio access networks (RANs) 412 of edge sites 410 and a session management function (SMF) 423 facility and a unified data management (UDM) 424 facility. Session management function (SMF) 423 further interfaces with a policy control function (PCF) 425, in one embodiment.

In operation, user equipment 401, UE1, UE2, & UE3, represent, in one or more embodiments, one or more wireless user devices, such as smartphones, mobile phones, gaming devices, wireless vehicle devices/systems, wireless computers, etc., which can change their point of attachment in the cellular network 400 by movement or migration away from a cell tower in one cell region to a cell tower in another cell region of the network. In such a case, a wireless session can start to be served by a network application-aware server, or “edge app” server, with the state of the edge app server associated with the user device being migrated from a prior edge server at a source node to a new edge server at a destination node or site. As noted, the cellular network includes respective cell towers 411 and associated edge-of-network components and infrastructure 413, such as one or more computing resources (such as, one or more servers) that are functioning as, or part of, the cell that the mobile user equipment is in communication with.

As a mobile device moves out of communication range with a first edge site, the cellular network automatically enables an edge site in another geographical area to maintain the communication session with the user device over a new communication path. This functionality is inherent in cellular network 400 to maintain a current communication session between the user device and one or more cell towers as the user device moves from one area to another.

To affect the seamless transition, the cellular network infrastructure includes radio access networks (RANs) 412, such as the 5G new radio (NR) wireless air interface with a logical 5G radio node (gNB). Radio access networks 412 provide control and management of the radio transceivers of the cell node (base transceiver station) equipment, as well as perform management tasks, such as hand-off of a cell communication session. Typically, the cellular network interfaces via, for instance, the Internet, and facilitates control of elements necessary to provide application services to an end-user including, for instance, radio spectrum allocation, wireless network infrastructure, back-haul infrastructure, provisioning computer systems, etc.

As noted, with the advent of 5G networks, latency-sensitive applications, such as enterprise applications, manufacturing applications, health care applications, IoT applications, etc., are moving closer to the edge of the cellular network, and being run increasingly as services, or microservices. FIG. 4B depicts an example of this, where edge site 2 (in the example of FIG. 4A) includes, for instance, a container orchestrator 450, with a cluster control 451, such as a container control, interfacing with multiple nodes 452 (e.g., servers), each supporting one or more higher level software constructs, or pods 453, Pod1, Pod2, etc., each including one or more service applications 455 (or edge applications, such as App1, App2, App3). In one or more implementations, edge site computing infrastructure 413, along with tower 411 and radio access network 412, perform edge-site processing; with one or more of the edge sites running (in one embodiment) a container orchestrator 450, which orchestrates containerized applications to run on a cluster of host nodes. In operation, user equipment UE2 (e.g., a user mobile device) automatically selects the tower with the strongest signal, and the audio, video and/or Internet is processed from there. With movement of user equipment UE2, the appropriate tower is automatically reselected.

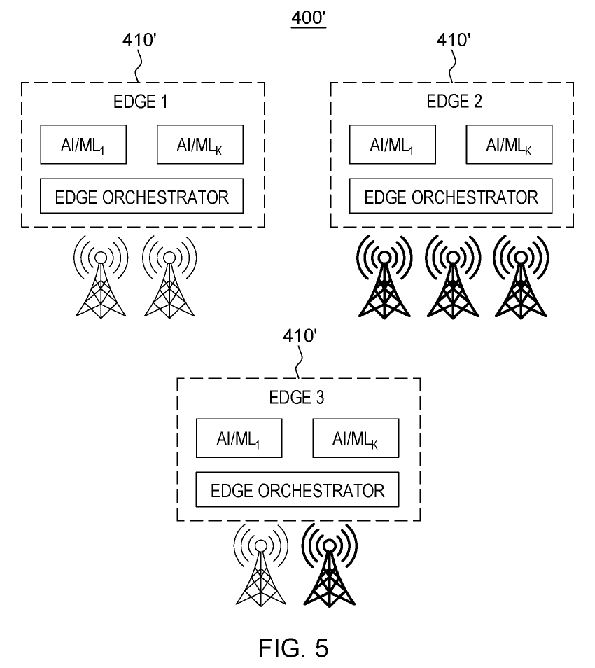

As illustrated in FIG. 5, at any point in time, different edge sites of a cellular network 400', such as cellular network 400 of FIGS. 4A-4B, can be providing or experiencing different service conditions. In practice, edge sites 410', such as edge sites 1, 2, & 3 in the embodiment of FIG. 5, can be, encompass, or use, one or more base stations, and can have limited resources that are to be leveraged most efficiently. The edge sites typically have different requirements and experience different user and control plane conditions throughout the day. In the embodiment of FIG. 5, edge site 1 is depicted with one or more lighter base stations that represent conditions with a majority of subscribers using, for instance, ultra-low latency services, while edge site 2 is depicted with one or more darker base stations representing conditions where the majority of subscribers are using enhanced mobile broadband services. Edge site 3 is currently experiencing conditions where subscribers are split between using ultra-low latency services and using enhanced mobile broadband services. In one or more embodiments disclosed herein, one or more codes (e.g., program codes or source codes) implemented by, or running on, the network edge controller (or edge orchestrator), of one or more of the edge sites 410' of a cellular network 400' are to be adapted to the conditions of the respective edge sites where the code is executing. In this manner, cellular network 400' incorporates, or implements, one or more aspects of the present disclosure.

In one or more embodiments, artificial intelligence (AI)/machine learning (ML) code can be deployed on the network edge controllers or edge orchestrators (e.g., xAPPS on near-RT RICs in an open-radio access network) of a network to govern the behavior of the controllers (and/or base stations) at the edge sites, so as to tune the network edge operations in accordance with predicted conditions to develop on the edge sites, such as disclosed. For instance, optimal utilization of edge resources can vary throughout the day. For example, in the morning, an edge site can see a decline of subscribers with the subscribers at work, while in the afternoon, a surge of users can be encountered as the subscribers return from work, which can increase utilization of services, such as ultra-reliable low latency communications (uRLLC) services. Thus, the network spectrum used in morning hours is not necessarily the same as the spectrum used in evening hours at any particular edge site. This means that the code driving the network operations at the edge may not always be optimized for every condition that the code encounters.

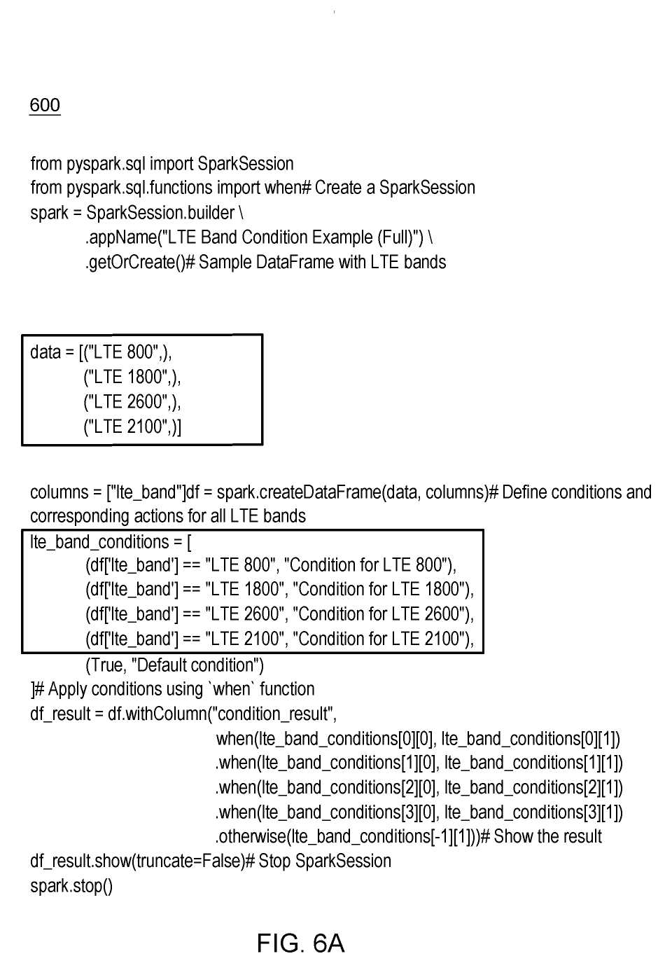

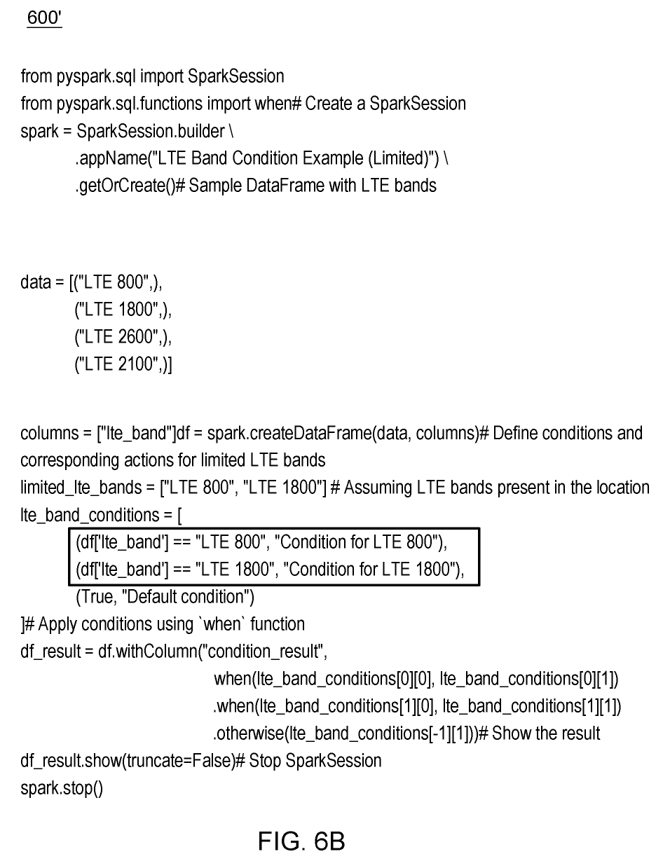

FIG. 6A-6B depict an exemplary embodiment of optimizing code (e.g. defining available network spectrum) covering one or more network edge operations at a network edge-controller-based on predicted edge condition development at the network edge controller, in accordance with one or more aspects of the present disclosure. In FIG. 6A, a portion of network code is illustrated where data and band conditions utilize all available long-term evolution (LTE) spectrums including LTE 800, LTE 1800, LTE 2600 & LTE 2100, in the depicted example. Should conditions at the edge site change, then one or more aspects of the code can be inactive. Inactive code, even though inactive, still impacts performance. For instance, the inactive code still occupies memory space and increases the size of the codebase at the edge node. FIG. 6B depicts the code of FIG. 6A, with the code having been reconfigured or optimized by tailoring the LTE spectrums to the predicted condition when only LTE 800 and LTE 1800 spectrum will be needed, or in use. In this example, the code governing one or more operations is optimized by removing certain inactive code portions, helping to reduce code memory usage and improve code execution speed on the edge node. Reducing memory usage is important for optimizing resource utilization, and improving execution speed is important for supporting, for instance, certain ultra-low latency use cases.

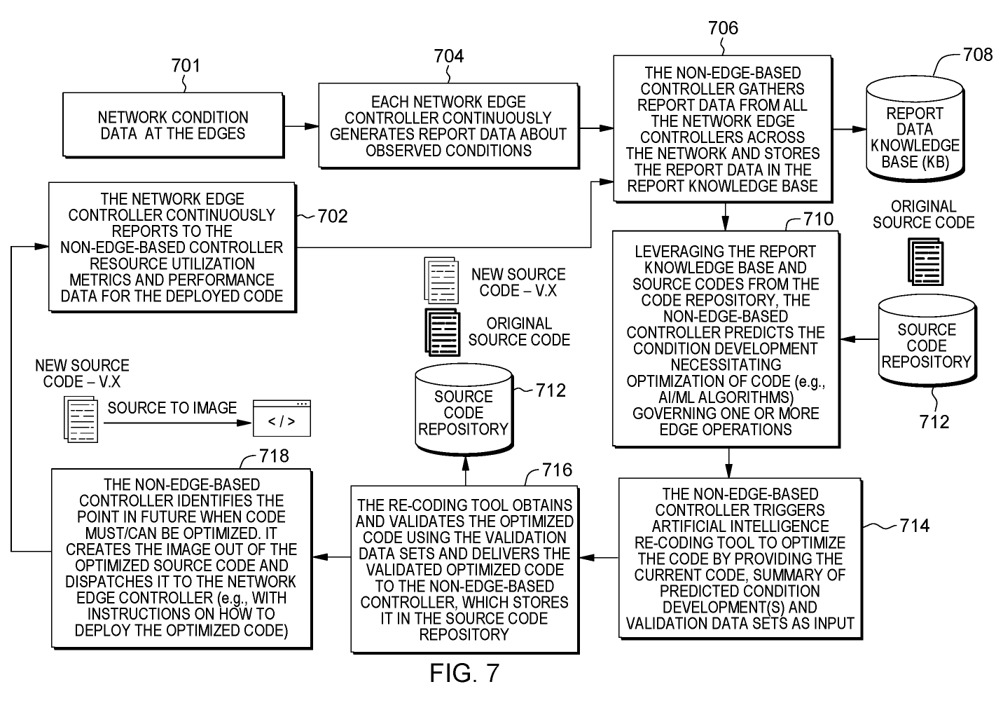

FIG. 7 depicts a more detailed embodiment of an edge-controller-code optimization workflow, in accordance with one or more aspects of the present disclosure. As illustrated, the edge-controller-code optimization workflow can include obtaining network condition data at the edges 701. As noted, the network conditions observed at the edge sites or edge nodes can change over a period of time, such as over a day, depending on the subscriber and service utilization patterns. In one or more embodiments, the network edge controllers continuously generate report data about the respective observed conditions 704. In one or more embodiments, the network edge controllers are near-RT RICs that continually generate and report out condition data, including, for instance, relevant user information, user segmentation, operational report data, etc. This condition and report data is referred to herein as user plane report data.

In one or more embodiments, a non-edge-based controller, such as a cloud-based controller (e.g., non-RT RIC 436 of FIG. 4A), gathers the report data 706 from one or more, or all, network edge controllers across the network and stores the report data in, for instance, a report data knowledge base (or database) 708. In addition to the user plane report data stored by the non-edge-based controller into report data knowledge base 708, the non-edge-based controller further receives gathered resource utilization metrics and performance data for the deployed code 702 on the one or more network edge controllers and stores that control data to the report data knowledge base 708. For instance, in one or more embodiments, the network edge controllers are near-RT RICs that periodically, or continuously, report to the non-edge-based controller resource utilization metrics and performance for deployed code, such as deployed artificial intelligence (AI)/machine learning (ML) code controlling network edge operations (and the available network spectrum) at the respective edge sites, including AI/ML operational logs. This information is referred to as control plane report data, which along with the user plane report data, is saved by the non-edge-based controller to the report data knowledge base 708.

In one or more embodiments, the edge-controller-code optimization workflow leverages the report knowledge base data and one or more network source codes to be, or being, executed by the network edge controllers obtained from a source code repository 712, to allow the non-edge-based controller to predict condition development at the different edge controllers, or nodes. Where appropriate, the non-edge-based controller initiates optimization of the code (e.g., optimization of one or more AI/ML algorithms or code segments) governing one or more edge operations 710. For instance, in one or more embodiments, leveraging the report data knowledge base 708 and the source code from the source code repository 712, the non-edge-based network controller predicts the user plane condition development that would necessitate optimizing the code (such as available network spectrums) of, for instance, one or more AI/ML algorithms governing edge operations at one or more network edge controllers.

In one or more embodiments, the non-edge-based controller triggers an artificial intelligence re-coding tool to optimize the code for the particular predicted network edge conditions by providing the current code, a summary of the predicted condition development(s) and a validation data set as input 714. For instance, in one or more embodiments, the non-edge-based controller (e.g., cloud-based controller) triggers a generative artificial intelligence re-coding tool to optimize the code by providing the current source code (e.g., current AI/ML code), the summary of the condition developments and a validation data set as input to the re-coding tool. Note that, in one or more embodiments, report data knowledge base 708 can follow a blockchain concept, and can be a distributed database over multiple network edge controllers, such as multiple near-RT RICs.

In one or more embodiments, the re-coding tool obtains and validates the optimized code 716. For instance, in one or more embodiments, source code repository 712 is accessed by the artificial intelligence re-coding tool, which reconfigures or tailors one or more code segments based on the predicted edge condition development. In this way, new source code, for instance, version V.X is obtained from an original source code. Validating of the optimized code can use the validation data sets obtained, for instance, from the report data knowledge base, and once validated, the validated optimized code is delivered, in one embodiment, to the non-edge-based controller, which stores it into source code repository 712. Note that, in one or more embodiments, the artificial intelligence re-coding tool, or generative artificial intelligence re-coding tool, can alternatively be implemented by, or integrated with, the non-edge-based controller, rather than be a tool executing on a computer resource separate from the non-edge-based controller. A number of variations are possible. As a specific example, the re-coding tool can be any available generative artificial intelligence re-coding tool that can facilitate generating and validating new optimized AI/ML code using the validation data set(s) such as disclosed herein, and deliver the validated code to the non-edge-based controller (e.g., non-RT RIC).

In one or more embodiments, the non-edge-based controller is configured to identify the point in the future when the code running on the network edge controller can be optimized 718. For instance, the non-edge-based controller can create a container image out of the optimized code and dispatch it to the network edge controller with, in one or more embodiments, instructions on how and when to deploy the optimized code. More particularly, in one example, a non-RT RIC can identify a point in time in the future when AI/ML code can or must be optimized, and create an image out of the optimized code, and dispatch the optimized code to the respective near-RT RIC with deployment instructions on how and when to deploy the optimized code.

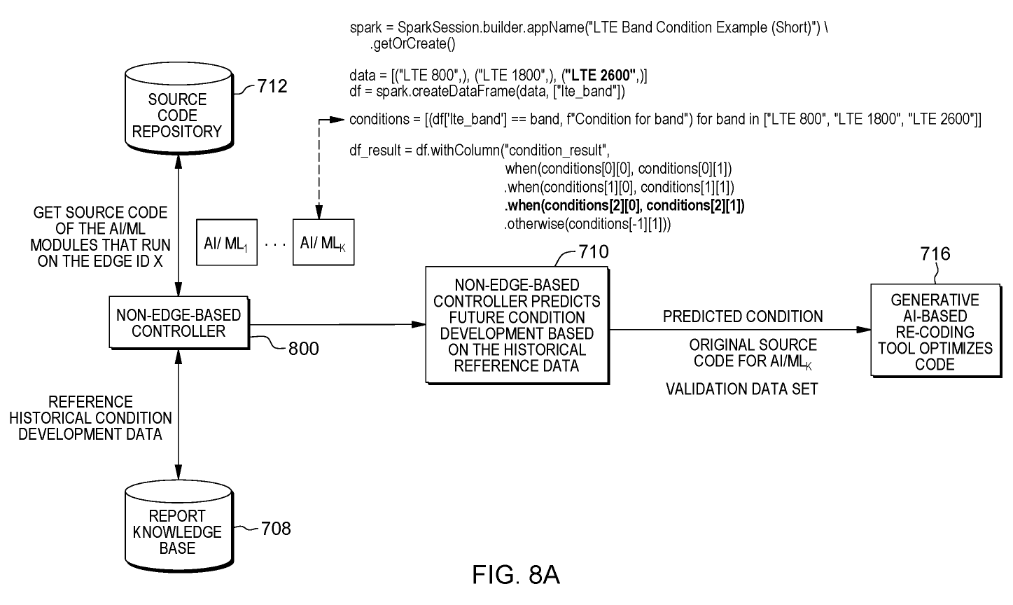

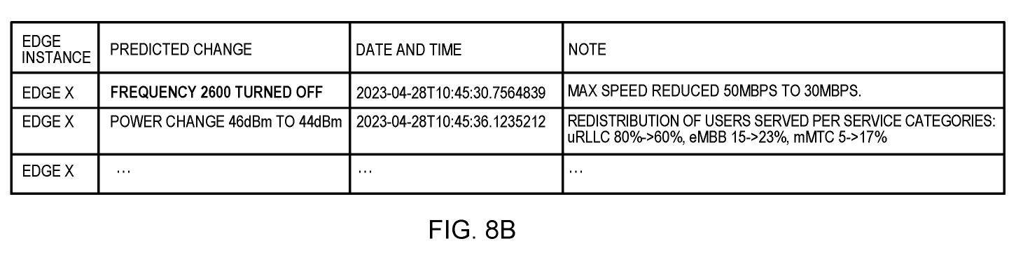

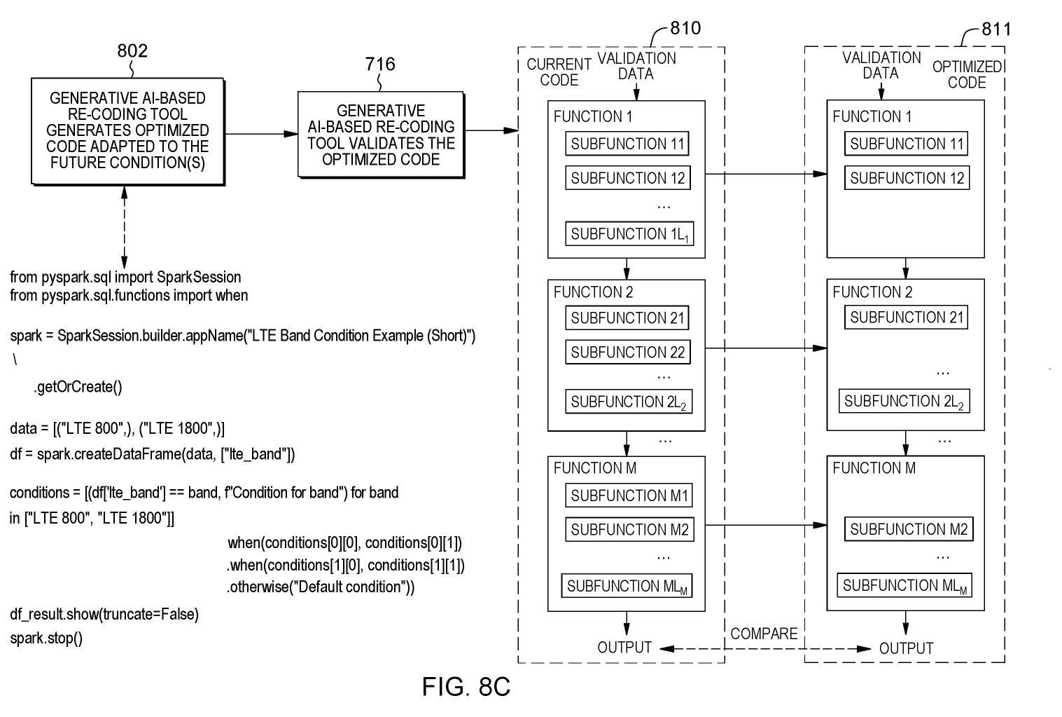

FIGS. 8A-8C depict a further exemplary embodiment of the edge-controller-code optimization workflow of FIG. 7. Referring initial to FIG. 8A, the non-edge-based controller (e.g., non-RT RIC) 800 executes for a particular network edge (e.g., edge site, edge node, etc.) the operational source code that runs on that network edge (e.g., at the particular edge id), and references historical condition development data for that edge from report data knowledge base 708. In one embodiment, the source code executing on the respective edge controllers includes one or more artificial intelligence/machine learning codes (AI/ML₁…AI/ML_{K}). In the example of FIG. 8A, a code segment is depicted where LTE 2600 is currently available, but is predicted to be turned off at a future time, as noted in the predicted data structure of FIG. 8B. In the embodiment illustrated, the non-edge-based controller predicts the future condition development at the edge controller based on the historical reference data 710 and provides the predicted condition, the original source code at issue (e.g., AI/ML_{K}, in one embodiment), and a validate data set to a generative AI-based re-coding tool that optimizes the code 716, such as described herein. The generative AI re-coding tool can be any existing AI-based re-coding tool or programming tool, or a future AI-based re-coding tool. As a particular example, the non-edge-based controller (e.g., non-RT RIC) is configured to predict the user plane condition development necessitating optimization of the code at issue, (such as one or more AI/ML algorithms), governing one or more network edge operations (including available network spectrum) at the particular edge controller. In the example of FIG. 8A, and as illustrated in FIG. 8B, the predicted change is that frequency 2600 is to be turned off at edge x at a point in time in the future. Based on this, the non-edge-based controller triggers the re-coding tool (e.g., generative artificial intelligence re-coding tool) to optimize the code by providing the current AI/ML code, the summary of the predicted condition development(s) and the validation data set as input, with the re-coding tool, in this case, re-coding the applicable source code to, at least in part, delete the LTE 2600 service. The optimized code is then provided for deployment at the identified time when the code is to be optimized based on the predicted condition, as illustrated further in FIG. 8C.

As depicted in FIG. 8C, the optimized code segment is shown, with LTE 2600 removed by the generative AI-based recoding tool. In this manner, the tool has adapted the optimized code to the future, predicted condition 802. In one or more embodiments, the generative AI-based recoding tool further validates the optimized code 716, with one embodiment of the validation process being depicted in FIG. 8C, where operations of current code 810 run and results are compared to the results of the optimized code 811. In one or more embodiments, the code runs using the provided validation data. In the embodiment depicted, the current code 810 includes multiple functions (function 1…function M), each of which is divided into multiple subfunctions. In the new, optimized code 811, subfunction 1L₁ is deleted, by way of example. For instance, in one or more embodiments, certain subfunctions can be commented out since they are not relevant anymore, and some subfunctions can be re-coded, depending on the code and the predicted condition(s) at the network edge controller to be optimized.

The terminology used herein is for the purpose of describing particular embodiments only and is not intended to be limiting of the invention. As used herein, the singular forms "a", "an", and "the" are intended to include the plural forms as well, unless the context clearly indicates otherwise. It will be further understood that the terms "comprise" (and any form of comprise, such as "comprises" and "comprising"), "have" (and any form of have, such as "has" and "having"), "include" (and any form of include, such as "includes" and "including"), and "contain" (and any form contain, such as "contains" and "containing") are open-ended linking verbs. As a result, a method or device that "comprises", "has", "includes", or "contains" one or more steps or elements possesses those one or more steps or elements, but is not limited to possessing only those one or more steps or elements. Likewise, a step of a method or an element of a device that "comprises", "has", "includes", or "contains" one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
predicting, via data analytics, edge condition development for a network edge controller of a network, the network including a plurality of network edge controllers with respective edge conditions;
determining, based on the predicting, that code governing one or more edge operations at the network edge controller can be optimized for the predicted edge condition development;
obtaining, based on the determining, optimized code to replace the code governing the one or more edge operations at the network edge controller, the optimized code optimizing the one or more edge operations at the network edge controller for the predicted edge condition development; and
transmitting the optimized code to the network edge controller for deployment to optimize the one or more edge operations at the network edge controller based on the predicted edge condition development.

2. The computer-implemented method of claim 1, wherein obtaining the optimized code comprises generating, via generative artificial intelligence re-coding of the code, the optimized code to replace the code governing the one or more edge operations at the network edge controller to optimize the one or more edge operations at the network edge controller for the predicted edge condition development.

3. The computer-implemented method of claim 2, further comprising validating the optimized code using one or more validation data sets as input, the validating being prior to deploying the optimized code on the network edge controller.

4. The computer-implemented method of claim 1, wherein the code is selected from the group consisting of artificial intelligence-based code and machine learning-based code.

5. The computer-implemented method of claim 1, further comprising identifying, based on the predicted edge condition development for the network edge controller, a point in time for optimizing the code by replacing the code with the optimized code at the network edge controller.

6. The computer-implemented method of claim 5, further comprising deploying the optimized code at the network edge controller at the identified point in time to dynamically optimize the one or more edge operations at the network edge controller based on the predicted edge condition development.

7. The computer-implemented method of claim 1, wherein predicting the edge condition development for the network edge controller comprises predicting, via data analytics, user plane condition development for the network edge controller of the network.

8. The computer-implemented method of claim 7, wherein the network edge controller comprises an edge-based radio access network (RAN) intelligent controller, and the one or more edge operations at the network edge controller comprise one or more network operations at the network edge controller.

9. The computer-implemented method of claim 8, wherein the predicting, the determining, the obtaining and the transmitting are by a non-edge-based controller of the network, the non-edge-based controller performing the predicting, the determining, the obtaining and the transmitting for multiple network edge controllers of the plurality of network edge controllers, and wherein the obtained optimized code for at least two network edge controllers of the multiple network edge controllers is different.

10. A computer program product comprising:
a set of one or more computer-readable storage media; and
program instructions, collectively stored in the set of one or more storage media, for causing at least one processor set to perform computer operations comprising:
predicting, via data analytics, edge condition development for a network edge controller of a network, the network including a plurality of network edge controllers with respective edge conditions;
determining, based on the predicting, that code governing one or more edge operations at the network edge controller can be optimized for the predicted edge condition development;
obtaining, based on the determining, optimized code to replace the code governing the one or more edge operations at the network edge controller, the optimized code optimizing the one or more edge operations at the network edge controller for the predicted edge condition development; and
transmitting the optimized code to the network edge controller for deployment to optimize the one or more edge operations at the network edge controller based on the predicted edge condition development.

11. The computer program product of claim 10, wherein obtaining the optimized code comprises generating, via generative artificial intelligence re-coding of the code, the optimized code to replace the code governing the one or more edge operations at the network edge controller to optimize the one or more edge operations at the network edge controller for the predicted edge condition development.

12. The computer program product of claim 11, wherein the computer operations further comprise validating the optimized code using one or more validation data sets as input, the validating being prior to deploying the optimized code on the network edge controller.

13. The computer program product of claim 10, wherein the code is selected from the group consisting of artificial intelligence-based code and machine learning-based code.

14. The computer program product of claim 10, wherein the computer operations further comprise identifying, based on the predicted edge condition development for the network edge controller, a point in time for optimizing the code by replacing the code with the optimized code in the network edge controller, and deploying the optimized code at the network edge controller at the identified point in time to dynamically optimize edge operations at the network edge controller based on the predicted edge condition development.

15. The computer program product of claim 10, wherein predicting the edge condition development for the network edge controller comprises predicting, via data analytics, user plane condition development for the network edge controller of the network, and wherein the network edge controller comprises an edge-based radio access network (RAN) intelligent controller, and the one or more edge operations at the network edge controller comprise one or more network operations at the network edge controller.

16. The computer program product of claim 15, wherein the predicting, the determining, the obtaining and the transmitting are by a non-edge-based controller of the network, the non-edge-based controller performing the predicting, the determining, the obtaining and the transmitting for multiple network edge controllers of the plurality of network edge controllers, and wherein the obtained optimized code for at least two network edge controllers of the multiple network edge controllers is different.

17. A computer system comprising:
at least one processor set;
a set of one or more computer-readable storage media; and
program instructions, collectively stored in the set of one or more storage media, for causing the at least one processor set to perform computer operations comprising:
predicting, via data analytics, edge condition development for a network edge controller of a network, the network including a plurality of network edge controllers with respective edge conditions;
determining, based on the predicting, that code governing one or more edge operations at the network edge controller can be optimized for the predicted edge condition development;
obtaining, based on the determining, optimized code to replace the code governing the one or more edge operations at the network edge controller, the optimized code optimizing the one or more edge operations at the network edge controller for the predicted edge condition development; and
transmitting the optimized code to the network edge controller for deployment to optimize the one or more edge operations at the network edge controller based on the predicted edge condition development.

18. The computer system of claim 17, wherein obtaining the optimized code comprises generating, via generative artificial intelligence re-coding of the code, the optimized code to replace the code governing edge operations at the network edge controller to optimize edge operations at the network edge controller for the predicted edge condition development, and wherein the computer operations further comprise validating the optimized code using one or more validation data sets as input, the validating being prior to deploying the optimized code on the network edge controller.

19. The computer system of claim 17, wherein the code is selected from the group consisting of artificial intelligence-based code and machine learning-based code.

20. The computer system of claim 17, wherein predicting the edge condition development for the network edge controller comprises predicting, via data analytics, user plane condition development for the network edge controller of the network, and wherein the network edge controller comprises an edge-based radio access network (RAN) intelligent controller, and the one or more edge operations at the network edge controller comprise one or more network operations at the network edge controller.
